(19) United States
(12) Patent Application Publication
(10) Pub. No.: US 2010/0060624 A1
(43) Pub. Date: Mar. 11, 2010

(54) DISPLAY UNIT, DISPLAY UNIT DRIVING METHOD AND DISPLAY SYSTEM

(75) Inventors: Yi-Cheng Chen, Guishan Shiang (TW); Heng-Yin Chen, Tuku Town (TW); Chao-Chiun Liang, Zhonghe City (TW)

Correspondence Address: LOWE HAUPTMAN HAM & BERNER, LLP, 1700 DIAGONAL ROAD, SUITE 300, ALEXANDRIA, VA, 22314, US

(73) Assignee: INDUSTRIAL TECHNOLOGY RESEARCH INSTITUTE, HSINCHU (TW)

(21) Appl. No.: 12/326,671

(22) Filed: Dec. 2, 2008

(30) Foreign Application Priority Data
Sep. 5, 2008 (TW) 97134043

(51) Int. Cl. G09G 5/00

(52) U.S. Cl. 345/212

(57) ABSTRACT

A display unit including a capacitor, a pixel and a switch is provided. The capacitor is charged or discharged in response to a voltage difference between a drain control signal and a common voltage signal. The pixel displays in response to the voltage difference between the drain control signal and the common voltage signal. The switch is turned on according to a switch control signal and transmits a source control signal through the third terminal to the pixel and the capacitor. The switch is turned on twice within every one frame according to the switch control signal, and when the switch is turned on for the first time, the pixel displays, and when the switch is turned on for the second time, the capacitor is discharged to avoid a voltage at the third terminal of the switch to exceed a predetermined voltage.

### BACKGROUND OF THE INVENTION

1. Field of the Invention

The invention relates to a display driving method, and more particularly to an AC-V_{com} display driving method.

2. Description of the Related Art

FIG. 1 shows a conventional display unit 10 and the timing diagram of multiple signals V_{Gn}, V_{Sn}, V_{com}, V_{Cst} and V_{Dn}. Display unit 10 includes a switch 14, a pixel 12 and a capacitor 16. Switch control signal V_{Gn} controls the on or off status of the switch 14. When the switch 14 is turned on, the source control signal V_{Sn} and the drain control signal V_{Dn} are at the same voltage level. The capacitor 16 is charged in response to the voltage difference between the drain control signal V_{Dn} and the common voltage signal V_{com}. The pixel 12 and capacitor 16 are connected in parallel, wherein one terminal receives the drain control signal V_{Dn}, and the other terminal receives the common voltage signal V_{com}. In this manner, once there is voltage difference between the two terminals of the pixel 12, pixel 12 displays, wherein the common voltage signal V_{com} is an alternating current common voltage signal AC-V_{com}.

It can be seen from FIG. 1 that the switch 14 outputs the drain control signal V_{Dn} to one terminal of the capacitor 16 and the pixel 12. Due to the coupling effect of the capacitor, before the switch 14 is turned on, the alternating common voltage signal V_{com} causes the voltage of the drain control signal V_{Dn} to be extremely high or extremely low, which results in the switch 14, generating large current leakage or the switch 14, being damaged.

### BRIEF SUMMARY OF THE INVENTION

A display unit, display unit driving method, and display system are provided. An exemplary embodiment of a display unit comprises a capacitor, a pixel and a switch. The capacitor is charged or discharged in response to a voltage difference between a drain control signal and a common voltage signal. The pixel displays in response to the voltage difference between the drain control signal and the common voltage signal. The switch includes a first terminal receiving a source control signal (V_{Sn}), a second terminal receiving a switch control signal (V_{Gn}) and a third terminal coupled to the pixel and the capacitor. The switch is turned on according to the switch control signal and transmits the source control signal through the third terminal to the pixel and the capacitor. The switch is turned on twice within every one frame according to the switch control signal. When the switch is turned on for the first time, the pixel displays, and when the switch is turned on for the second time, the capacitor is discharged to avoid a voltage at the third terminal of the switch to exceed a predetermined voltage.

An exemplary embodiment of a display unit driving method for driving a display unit including a pixel, a switch and a capacitor comprises: turning on the switch (the first time) within one frame according to a switch control signal (V_{Gn}) so as to charge a voltage of the capacitor to a specific voltage level according to a voltage difference between a drain control signal and a common voltage signal; turning off the switch and the pixel displaying according to the voltage of the capacitor; and turning on the switch (the second time) within the frame according to the switch control signal and discharging the capacitor according to the voltage difference between the drain control signal and the common voltage signal, so as to avoid a voltage at a terminal where the switch is coupled to the capacitor to exceed a predetermined voltage.

An exemplary embodiment of a display system for display images comprises a gate driver, a source driver and a display device. Each display unit comprises a capacitor, a pixel and a switch. The capacitor comprises two terminals for respectively receiving a drain control signal (V_{Dn}) from the source driver and a common voltage signal (V_{com}), and is charged or discharged according to a voltage difference between the drain control signal and the common voltage signal. The pixel comprises two terminals for respectively receiving the drain control signal and the common voltage signal, and displays in response to the voltage difference between the drain control signal and the common voltage signal. The switch comprises a first terminal receiving a source control signal (V_{Sn}), a second terminal receiving a switch control signal (V_{Gn}) from the gate driver and a third terminal coupled to the pixel and the capacitor, wherein the switch is turned on according to the switch control signal and transmits the source control signal through the third terminal to the pixel and the capacitor. The switch is turned on twice within every one frame according to the switch control signal, wherein when the switch is turned on for the first time, the pixel displays, and when the switch is turned on for the second time, the capacitor is discharged to avoid the voltage at the third terminal of the switch to exceed a predetermined voltage.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a conventional display unit and the timing diagram of multiple signals;

FIG. 2 shows the display unit and the timing diagram of multiple signals according to a first embodiment of the invention;

FIG. 3 shows the display unit and the timing diagram of multiple signals according to a second embodiment of the invention;

FIG. 4 shows the display unit and the timing diagram of multiple signals according to a third embodiment of the invention;

FIG. 5 shows a display system 50 according to a fourth embodiment of the invention; and

FIG. 6 shows a timing diagram of the gate driver, the display device, and a plurality of switch control signals according to a fifth embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

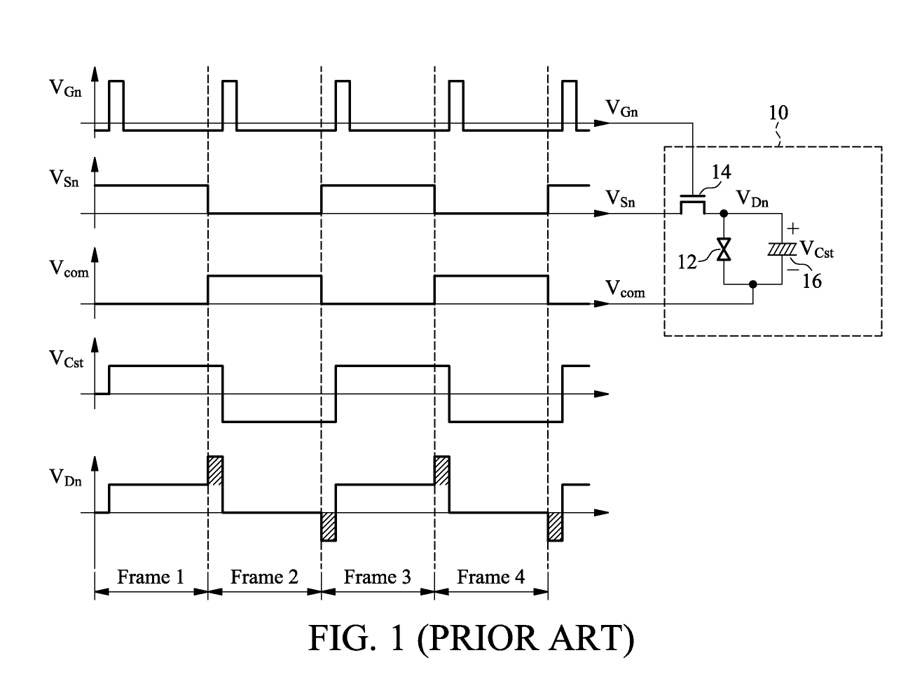

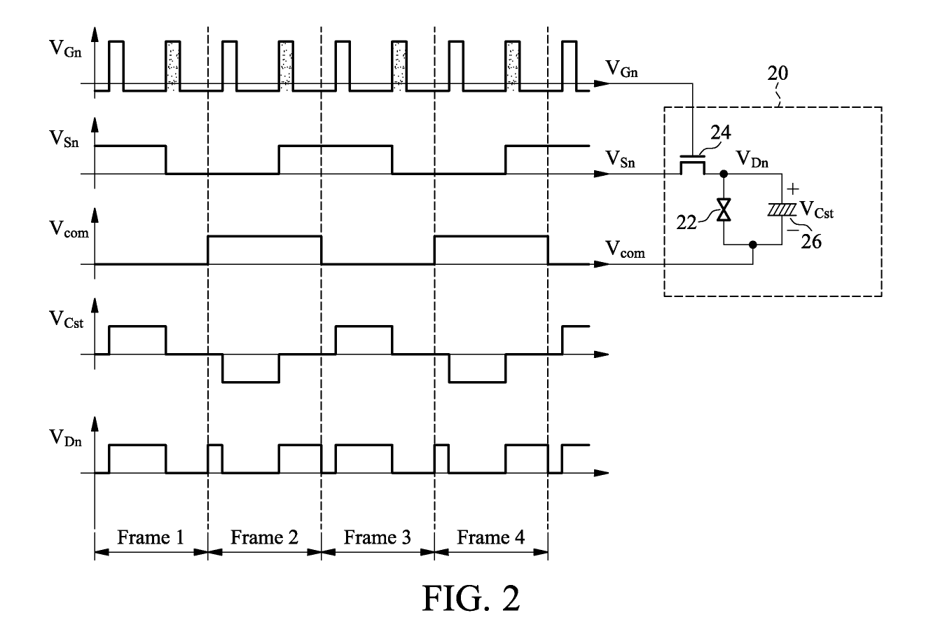

FIG. 2 shows the display unit 20 and the timing diagram of multiple signals V_{Gn}, V_{Sn}, V_{com}, V_{Cst} and V_{Dn} according to a first embodiment of the invention. Display unit 20 comprises a switch 24, a pixel 22 and a capacitor 26. The switch 24 may be a transistor. The switch 24 comprises a first terminal to receive a source control signal (V_{Sn}), a second terminal to receive a switch control signal (V_{Gn}) and a third terminal coupled to the pixel 22 and the capacitor 26. The switch 24 is turned on according to the switch control signal V_{Gn} so as to transmit the source control signal V_{Sn} through the third terminal to the pixel 22 and the capacitor 26. When the switch 24 is turned on, the source control signal V_{Sn} and the drain control signal V_{Dn} are at the same voltage level. The capacitor 26 comprises two terminals for respectively receiving the drain control signal (V_{Dn}) and a common voltage signal (V_{com}), and is charged or discharged according to a voltage difference V_{Cst} (capacitor voltage difference) between the drain control signal V_{Dn} and the common voltage signal V_{com}. The pixel 22 and capacitor 26 are connected in parallel. The pixel 22 comprises two terminals for respectively receiving the drain control signal V_{Dn} and the common voltage signal V_{com}, and displays in response to the voltage difference between the drain control signal V_{Dn} and the common voltage signal V_{com}. When there is voltage difference between two terminals of the pixel 22, the pixel 22 displays. The common voltage signal V_{com} is an alternating current common voltage signal AC-V_{com}. The display units shown in FIG. 1 and FIG. 2 are with the same circuit structure. Thus, the problem of an unexpected high voltage being generated at the drain of the switch 24 is solved without changing the hardware structure of the display unit, thus, preventing the switch from being damaged or generating large current leakage.

According to an embodiment of the invention, the switch 24 is turned on twice according to the switch control signal V_{Gn} within every one frame. When the switch 24 is turned on for the first time, the pixel 22 displays and the capacitor 26 is charged. When the switch 24 is turned on for the second time (the square with dots drawn inside as shown in FIG. 2), the voltage of the capacitor 26 is discharged at a low voltage level to avoid the voltage at the third terminal of the switch 24 to exceed a predetermined voltage. Since the voltage at the third terminal of the switch 24 is firstly lowered to a low voltage level, for the next frame, the voltage at the third terminal of the switch 24 may not exceed the predetermined voltage due to the alternating V_{com} and the coupling effect of the capacitor. Thus, mitigating the large leakage current problem of switch 24.

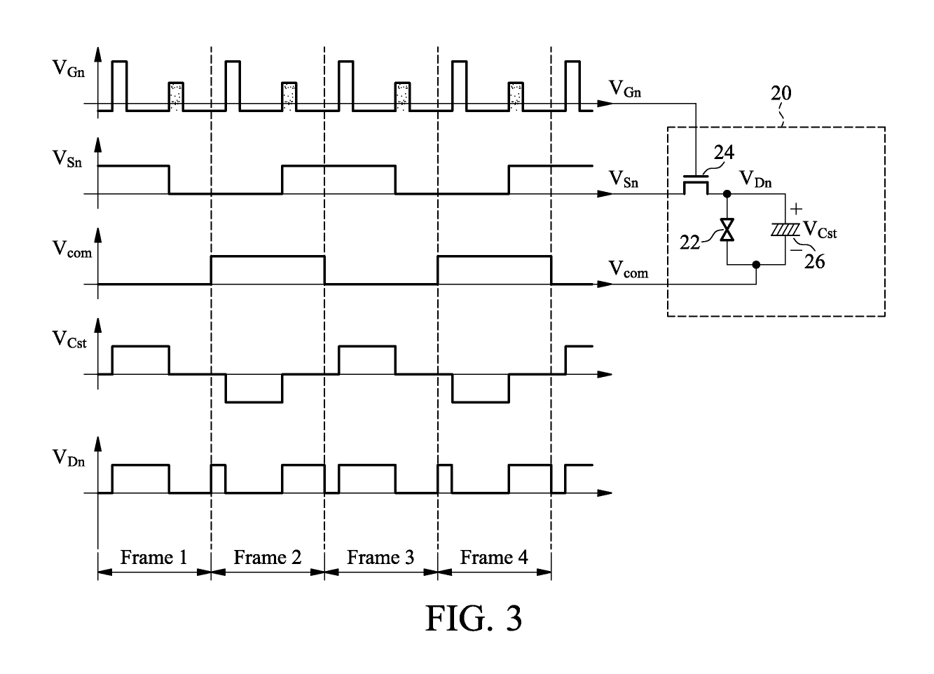

FIG. 3 shows the display unit 20 and the timing diagram of multiple signals V_{Gn}, V_{Sn}, V_{com}, V_{Cst} and V_{Dn} according to a second embodiment of the invention. The difference between the first and the second embodiments is that the voltage level of the switch control signal V_{Gn} is lower in the second embodiment during the second time the switch is turned on. Thus, discharge speed and discharge voltage of the capacitor 26 are controlled by the switch control signal V_{Gn}.

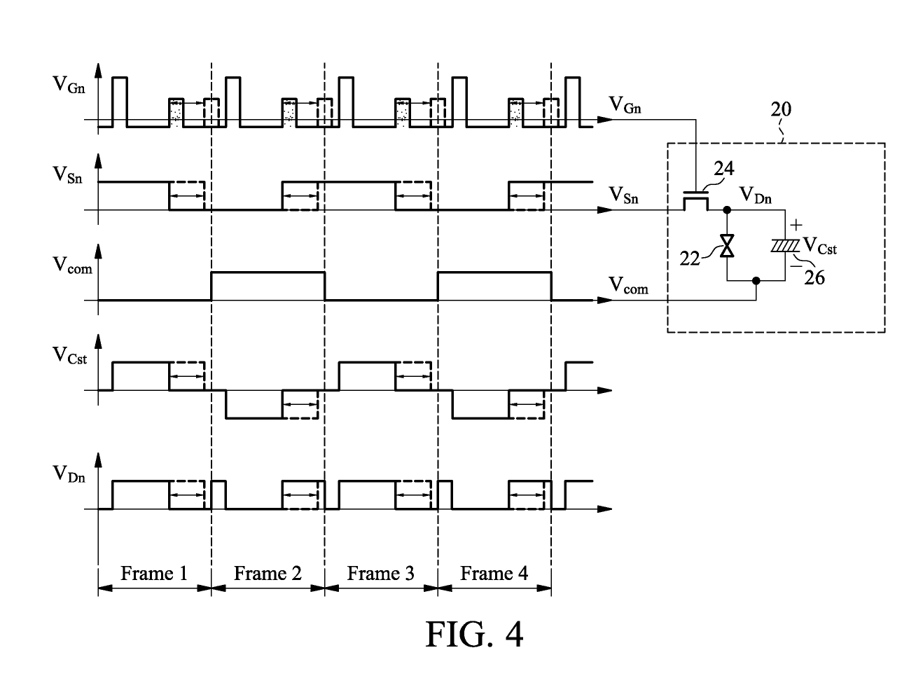

FIG. 4 shows the display unit 20 and the timing diagram of multiple signals V_{Gn}, V_{Sn}, V_{com}, V_{Cst} and V_{Dn} according to a third embodiment of the invention. The difference between the second and the third embodiments is that the timing of the switch being turned on for the second time is adjustable within the frame.

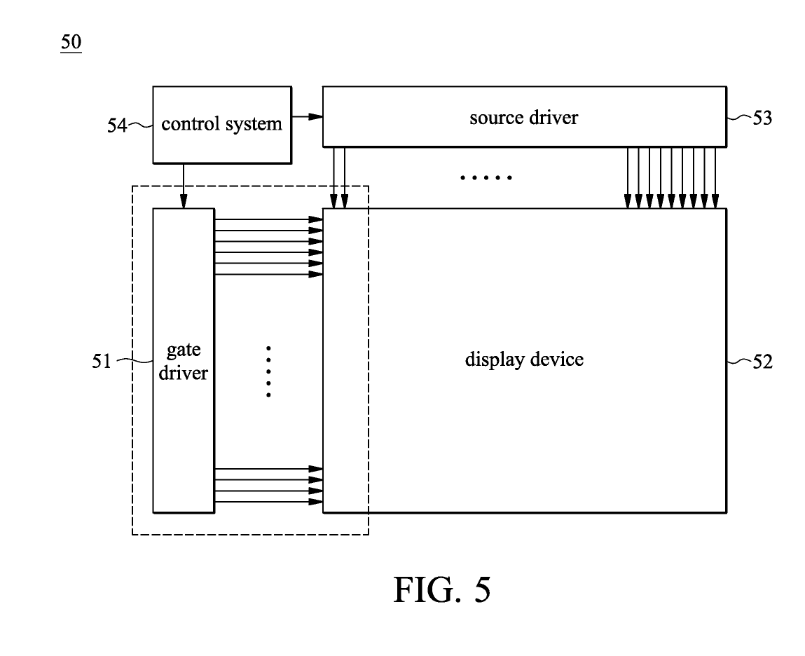

FIG. 5 shows a display system 50 according to a fourth embodiment of the invention. The display system 50 comprises a control system 54, a gate driver 51, a source driver 53 and a display device 52, wherein the display device 52 comprises a plurality of display units; as an example, the display unit 20 shown in FIG. 2.

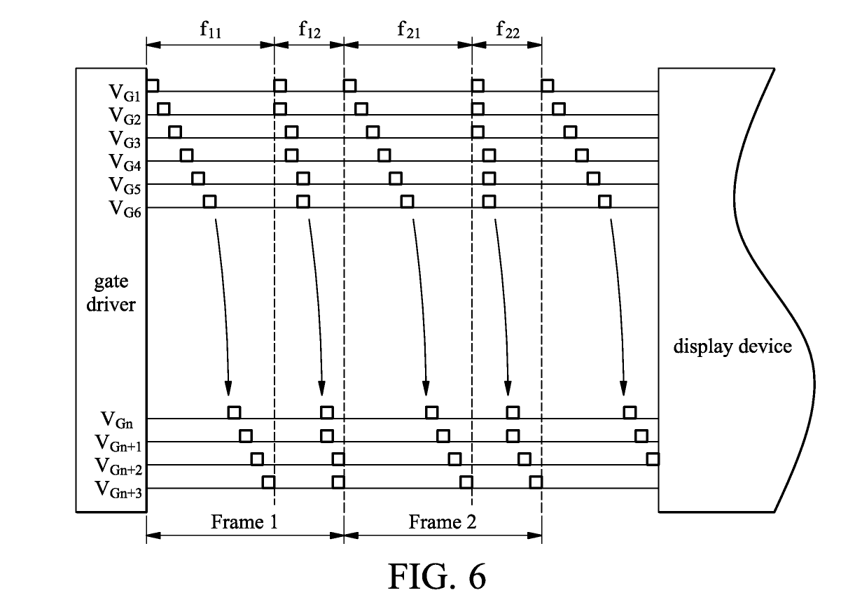

FIG. 6 shows a timing diagram of the gate driver 51, the display device 52, and a plurality of switch control signals V_{Gn} according to a fifth embodiment of the invention. A gate driver 51 controls the timing of each switch control signal V_{Gn} being output to the second terminal of the switch 24 in each display unit 20 of the display device 52. As an example, within Frame 1, there is a driving period f₁₁ and a capacitor discharge period f₁₂, and within Frame 2, there is a driving period f₂₁ and a capacitor discharge period f₂₂. Switch control signals V_{G1}-V_{Gn+3} are sequentially transmitted to each corresponding display unit during the driving periods f₁₁, and f₂₁. Thus, the corresponding switches are sequentially turned on to charge the corresponding capacitor and then the corresponding pixels display. Two or several switch control signals V_{G1}-V_{Gn+3} may be grouped together and each group may be sequentially transmitted to the corresponding display unit so as to turn on the corresponding switches to discharge the corresponding capacitor.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A display unit, comprising:
a capacitor comprising two terminals for respectively receiving a drain control signal (V_{Dn}) and a common voltage signal (V_{com}), and being charged or discharged in response to a voltage difference between the drain control signal and the common voltage signal;
a pixel comprising two terminals for respectively receiving the drain control signal and the common voltage signal, and displaying in response to the voltage difference between the drain control signal and the common voltage signal; and
a switch comprising a first terminal receiving a source control signal (V_{Sn}), a second terminal receiving a switch control signal (V_{Gn}) and a third terminal coupled to the pixel and the capacitor, wherein the switch is turned on according to the switch control signal and transmits the source control signal through the third terminal to the pixel and the capacitor,
wherein the switch is turned on twice within every one frame according to the switch control signal, and when the switch is turned on for the first time, the pixel displays, and when the switch is turned on for the second time, the capacitor is discharged.

2. The display unit as claimed in claim 1, wherein when the switch is turned on for the first time, the capacitor is charged and the pixel displays.

3. The display unit as claimed in claim 1, wherein when the switch is turned on for the second time, voltage of the capacitor is discharged at a low voltage level to avoid a voltage at the third terminal of the switch to exceed a predetermined voltage.

4. The display unit as claimed in claim 1, wherein the timing of the switch being turned on for the second time is adjustable within the frame.

5. The display unit as claimed in claim 1, wherein discharge speed and discharge voltage of the capacitor are controlled by the switch control signal.

6. A display unit driving method, wherein a display unit comprises a pixel, a switch and a capacitor, comprising:
turning on the switch (the first time) within a frame according to a switch control signal (V_{Gn}) so as to charge a voltage of the capacitor to a specific voltage level according to a voltage difference between a drain control signal and a common voltage signal, after that turning off the switch and the pixel displaying according to the voltage of the capacitor; and
turning on the switch (the second time) within the frame according to the switch control signal and discharging the capacitor according to the voltage difference between the drain control signal and the common voltage signal.

7. The display unit driving method as claimed in claim 6, wherein when the switch is turned on for the second time, the voltage of the capacitor is discharged at a low voltage level, so as to avoid a voltage at a terminal where the switch is coupled to the capacitor to exceed a predetermined voltage.

8. The display unit driving method as claimed in claim 6, wherein the timing of the switch being turned on for the second time is adjustable within the frame.

9. The display unit driving method as claimed in claim 6, wherein discharge speed and discharge voltage of the capacitor are controlled by the switch control signal.

10. A display system for display images comprising a gate driver, a source driver and a display device, wherein the display device comprises a plurality of display units, and each display unit comprises:
a capacitor comprising two terminals for respectively receiving a drain control signal (V_{Dn}) from the source driver and a common voltage signal (V_{com}), and being charged or discharged according to a voltage difference between the drain control signal and the common voltage signal;
a pixel comprising two terminals for respectively receiving the drain control signal and the common voltage signal, and displaying in response to the voltage difference between the drain control signal and the common voltage signal; and
a switch comprising a first terminal receiving a source control signal (V_{Sn}), a second terminal receiving a switch control signal (V_{Gn}) from the gate driver and a third terminal coupled to the pixel and the capacitor, wherein the switch is turned on according to the switch control signal and transmits the source control signal through the third terminal to the pixel and the capacitor,
wherein the switch is turned on twice within every one frame according to the switch control signal, and when the switch is turned on for the first time, the pixel displays, and when the switch is turned on for the second time, the capacitor is discharged.

11. The display system as claimed in claim 10, wherein the gate driver controls the timing of each switch control signal being output to the second terminal of the switch of each display unit.

12. The display system as claimed in claim 10, wherein when the switch is turned on for the first time, the capacitor is charged and the pixel displays.

13. The display system as claimed in claim 10, wherein when the switch is turned on for the second time, voltage of the capacitor is discharged at a low voltage level to avoid the voltage at the third terminal of the switch to exceed a predetermined voltage.

14. The display system as claimed in claim 10, wherein the timing of the switch being turned on for the second time is adjustable within the frame.

15. The display system as claimed in claim 10, wherein discharge speed and discharge voltage of the capacitor are controlled by the switch control signal.
